(19) United States
(12) Patent Application Publication
(10) Pub. No.: US 2017/0349084 A1
(43) Pub. Date: Dec. 7, 2017

(54) Locking Mechanism For Roll Off Hoist Containers

(71) Applicant: The Heil Co., Chattanooga, TN (US)

(72) Inventor: John Peter S, Bangalore (IN)

(21) Appl. No.: 15/613,445

(22) Filed: Jun. 5, 2017

Related U.S. Application Data
(60) Provisional application No. 62/346,051, filed on Jun. 6, 2016.

(51) Int. Cl. B60P 7/13; B60P 1/44; B60P 1/64; B60P 7/06

(52) U.S. Cl. CPC B60P 7/13; B60P 1/6454; B60P 1/4421; B60P 7/06

(57) ABSTRACT

A locking mechanism has a guide and a vertically movable plate. The plate is movable in the guide under gravitational influence between a locked position and an unlocked position. A slot is formed in the plate to receive a guide pin. The guide pin maintains the movable plate in the guide. The slot enables axial vertical movement of the plate in the guide. The plate moves into the locked position upon contact with a surface. In this position, the plate projects from the guide to lock a roll off container onto the hoist. The movable plate reverts to the unlocked position upon removal of the surface so that the plate moves into the guide.

### CROSS-REFERENCE TO RELATED APPLICATIONS

This application claims the benefit of U.S. Provisional Application No. 62/346,051, filed on Jun. 6, 2016. The entire disclosure of the above application is incorporated herein by reference.

### FIELD

The present disclosure relates to vehicles that transport refuse roll off containers and, more particularly, to a locking mechanism to secure the roll off container to a hoist on the vehicle.

### BACKGROUND

During transporting of refuse roll away container, generators or the like, it is desirable to lock the container onto the hoist during transport so that the container is unable to move on the hoist. Types of devices exist to secure and lock these roll off containers with the hoists. While these types of locking devices are satisfactory to lock the roll off containers with the hoists, designers strive to improve the art.

The present disclosure provides the art with a device that locks roll off containers to a hoist. The device is influenced by gravity to move the device between a locked and an unlocked position. The present disclosure provides a movable plate that moves vertically with respect to the hoist. The movable plate moves between a locking position, where a surface forces the movable plate to extend out of a guide above the hoist rail, to an unlocking position, where the movable plate passes through the hoist rail.

### SUMMARY

Accordingly to a first aspect of the disclosure, a locking mechanism to secure a roll off container to a hoist comprises a guide with a vertically moving plate. The plate is movable in the guide under gravitational influence between a locked position and an unlocked position. A slot is formed in the movable plate to receive a guide pin. The guide pin maintains the movable plate in the guide. The slot enables vertical movement of the plate in the guide such that the movable plate moves into the locked position upon contact of the plate with a surface on the frame. The plate projects from the guide to lock the roll off container onto the hoist. The plate reverts to the unlocked position upon removal of the surface so that the movable plate moves into the guide by gravity. The plate has an overall elongated rectangular configuration with a pair of parallel sides. One end of the plate, between the parallel sides, has a tapered portion with a radiused corner. The slot is defined by a pair of parallel edges that is parallel with the parallel sides.

According to a second object of the disclosure, a vehicle having a roll off container locking mechanism comprises a vehicle with a frame and a powertrain to drive the vehicle. A hoist is positioned on the frame. The hoist moves between a roll off container pickup position and a roll off container transport position. The locking mechanism is coupled with the hoist. The locking mechanism comprises a guide with a vertically moving plate. The plate is movable in the guide under gravitational influence between a locked position and an unlocked position. A slot is formed in the movable plate to receive a guide pin. The guide pin maintains the movable plate in the guide on the hoist. The slot enables vertical movement of the plate in the guide such that the movable plate moves into a locked position upon contact with a surface on the frame. The plate projects from the guide to lock the roll off container onto the hoist. The plate reverts to the unlocked position upon removal of the surface so that the movable plate moves into the guide on the hoist. The plate has an overall elongated rectangular configuration with a pair of parallel sides. One end of the plate, between the parallel sides, has a tapered portion with a radiused corner. The slot is defined by a pair of parallel edges that is parallel with the parallel sides. A front hold down is positioned on the hoist adjacent the locking mechanism. A portion of the roll off container is locked between the front hold down and the locking mechanism.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevation view of a refuse vehicle with a hoist for loading, unloading, and transporting roll off containers.

FIG. 2 is a side elevation view of a refuse vehicle with a roll off container attached to a cable on the hoist.

FIG. 3 is a side elevation view of a refuse vehicle with a container on the hoist.

FIG. 4 is a perspective view of the hoist and frame.

FIG. 5 is a detailed perspective view of the locking mechanism.

FIG. 6 is a side elevation view partially in section of the locking mechanism.

FIG. 7 is an elevation view of an additional embodiment of a locking plate.

FIG. 8 is a perspective view of an additional lift mechanism.

### DETAILED DESCRIPTION

Turning to the figures, a vehicle for loading, unloading, and transporting roll off containers is illustrated and designated with a reference numeral 10. The vehicle 10 typically includes a cab 12 and a chassis or vehicle frame 14. The vehicle 10 includes a drivetrain with an engine, shafts and wheels 16 that move the vehicle 10 in a conventional manner. A hoist 20, also known as a “tilt frame,” is adapted to be mounted on the chassis or frame 14.

The hoist 20 includes a pair of side rails 22, 24 and a lifting mechanism 26. In this regard, the use of the term “container” is not meant to be limiting. Although it is anticipated that the invention will be used primarily on refuse containers, it can be used to load or unload virtually any structure or object known today, including storage containers, portable generators and the like.

The hoist 20 is pivotally attached to the bed or frame 14 of the vehicle 10 in a conventional manner. The lifting mechanism is generally referred to by the reference numeral 26. A pair of hydraulic cylinders 38, 40 is used to rotate or tilt the hoist 20 relative to the frame 14 in a manner shown in the drawings. In this regard, the tilting of the hoist 20 is conventional with container vehicles of this type and it is not believed necessary to describe the tilting and pivoting mechanism in further detail. A hydraulic fluid for the hydraulic cylinders used with the invention is typically contained in a fluid tank box 42. A control valve 44, for the hydraulic cylinders, is typically positioned adjacent the tank box 42.

As indicated, the free end of the cable 32 extends from the movable carriage 28. The cylinder 27 moves the carriage 28. The free end of the cable 32 is of sufficient length that it can be attached to a container 18 positioned behind or at the rear of the vehicle 10. The free end of the cable 32 may contain any conventional mechanism for latching to a container 18 such as a latch, clasp, or hook 46.

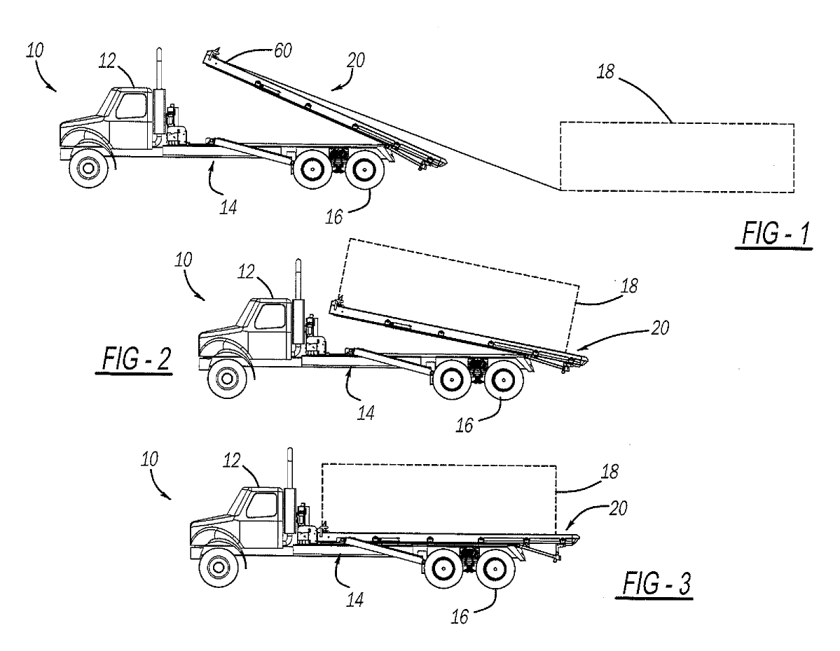

Once the cable 32 is attached to the container 18, as shown in FIG. 1, the vehicle operator operates the movable carriage 28. This moves the container onto the hoist 20 as illustrated in FIG. 2. The hook 46 or attaching mechanism has been attached to the container 18. The operator pulls the container 18, via the carriage 28, toward the hoist 20 and continues to load the container 18 all the way onto the hoist 20.

As the container 18 is loaded onto the hoist frame 20, it is pulled towards the end of the hoist 20. As this occurs, a bar 19 of the container 18 contacts a front hold down 52 to position the container 18 on the hoist 20. As the hoist 20 is moved towards the frame 14, a locking mechanism 60 locks the container 18 onto the hoist 20 as seen in FIG. 3.

The locking mechanism 60 is positioned adjacent the front hold down 52. The locking mechanism 60 secures the bar 19 or the like of the roll off container 18 to the hoist 20 during transport of the container 18.

The locking member 60 includes a plate 62 that is held within a guide 64 within the rail 22. The guide 64 includes an aperture or bore 66 with a pair of guide plates 68 and 70 defining the sides of the bore 66. The guide plates 68, 70 help to prevent swaying of the locking plate 62 in the guide 64. The guide plates 68, 70 can be secured with the rail 22 to hold the guide 64 in position.

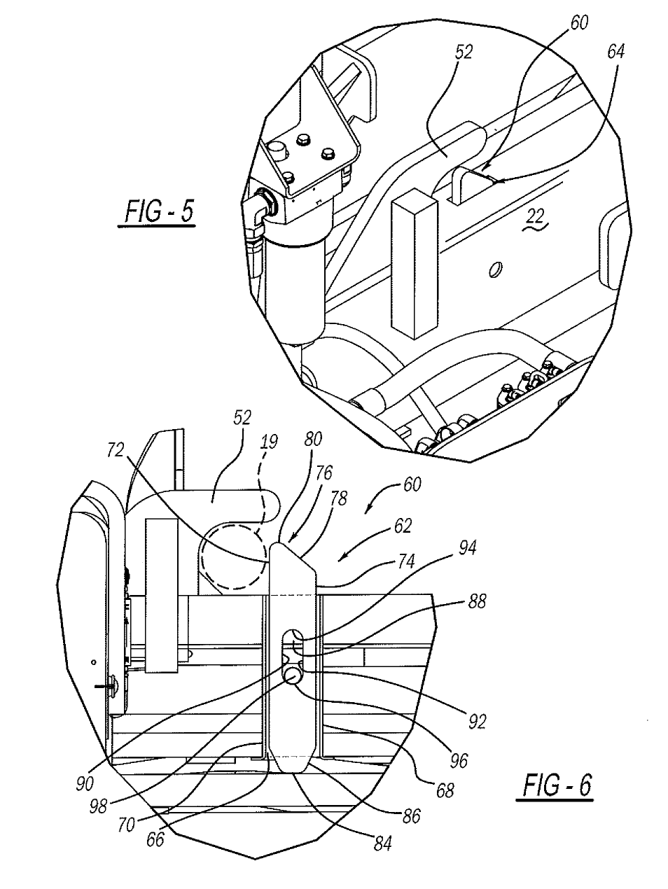

The plate 62 has an overall rectangular configuration as seen in FIG. 5. The plate 62 includes a pair of parallel sides 72, 74. The one end 76, between the parallel sides 72, 74, includes a tapered portion 78 and a radius corner 80. This enhances securement of the container 18 in the locking mechanism 60. The other end 82 includes a flat portion 84 that is substantially perpendicular to the parallel sides 72, 74. Also, tapered portions 86 extend from portion 84 to the parallel sides 72, 74. Any type of configuration could be utilized at this end to contact the frame surface.

A slot 88 is formed in the plate 62. The slot 88 is defined by a pair of parallel edges 90, 92. The edges 90, 92 are parallel to one another as well as parallel to the sides 72, 74. The ends of the slot 88 are defined by arcuate edges 94, 96. Thus, the slot 88 has an overall oval or elliptical configuration. A guide pin 98 is secured onto the rail 22. The guide pin 98 can be welded or the like so that the slot 88 receives the guide pin 98 in the bore 66 on the rail 22. Thus, the plate 62 moves vertically within the guide 64. The guide pin 98 also acts as a stop, contacting the arcuate edge 94 of the slot 88, to prohibit further movement of the plate 62 through the rail 22. Alternatively, slots could be formed in the rail 22 and a guide pin 98 could be formed on the plate 62. Thus, the guide pin 98 would move in the slots on the rail.

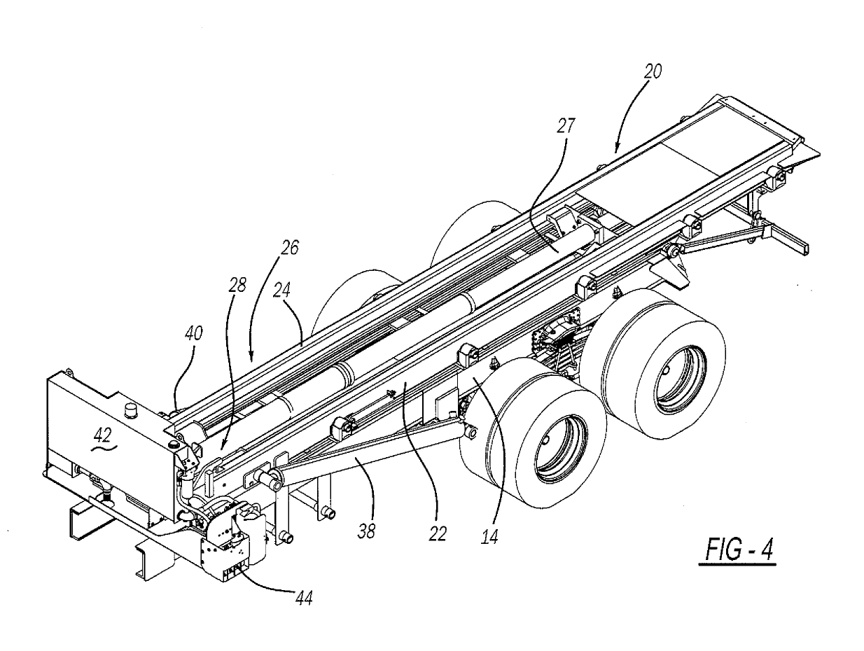

The mechanism for locking containers 60 is influenced by gravity. The gravitational influence enables the plate 62 to pass through the rail 22 when the rail 22 is moved away from the frame 14, as shown in phantom in FIG. 1. Also, when the rail 22 is in a down position adjacent the frame 14, the surface of the frame 14 pushes the plate 62 so that it projects from the rail 22 into a locking position, as seen in FIGS. 4 and 5. Accordingly, the locking mechanism 60 utilizes gravity to move the locking mechanism 60 between a locked and unlocked position.

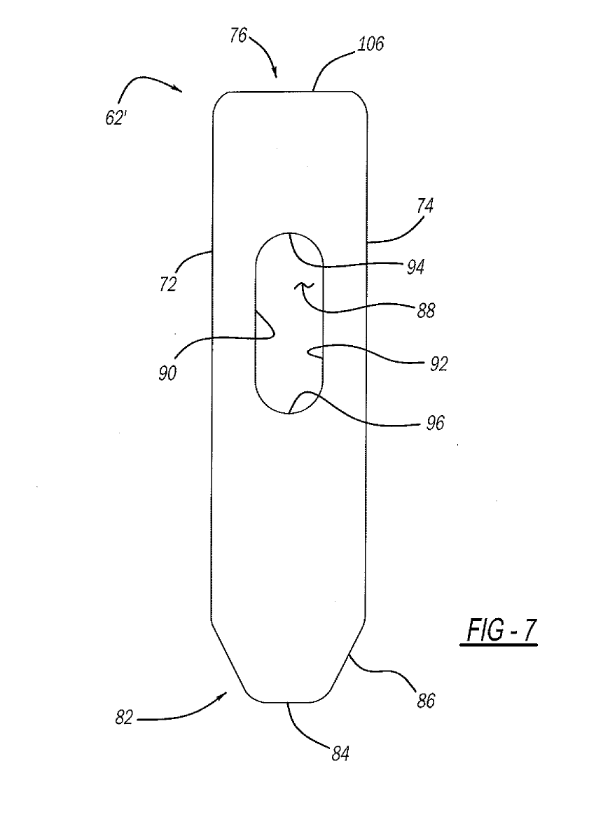

FIG. 7 illustrates an additional plate 62′. The same reference numerals have been used to identify the same features. Here, the plate 62′ includes a first end 104 that is perpendicular to sides 72, 74 and parallel to end portion 84. Here, the plate 62′ uses sides 72, 74 to contact the container 18.

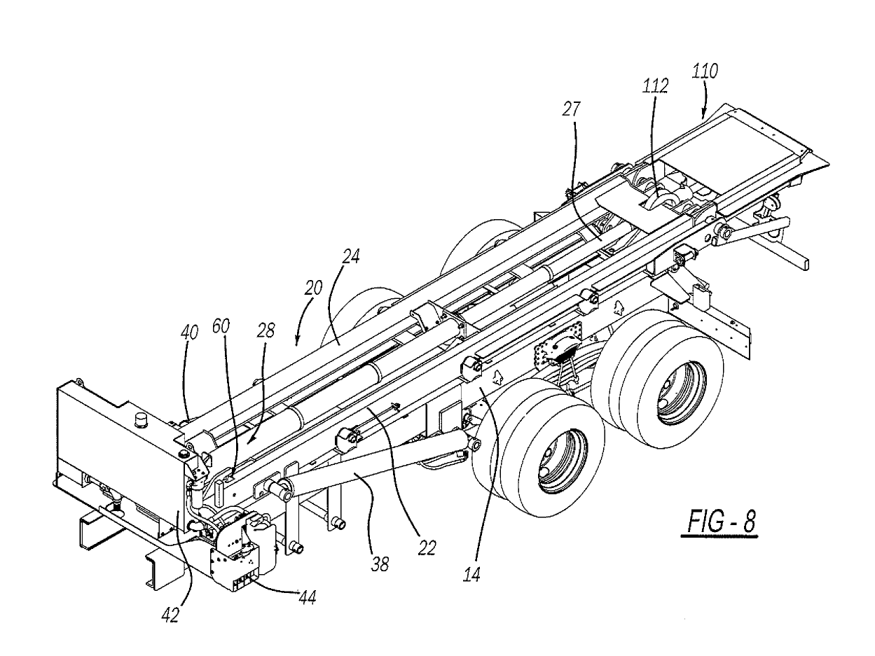

An additional refuse hoist is illustrated in FIG. 8. Here, it includes a hinged tail 110. A pulley or sheave 112, to accommodate cable movement, is positioned on the tilt frame 20 at the rotation point of the hinged tail member 110. This enables the cable 32 to easily follow along in the plane of the hinged tail member 110 when it is rotated to its down or lowered position.

The free end of the cable 32 is passed around the sheave 112. The free end of the cable 32 is of sufficient length that it can be attached to a container 18 positioned behind or at the rear of the vehicle 10.

Once the cable 32 is attached to the container 18, the vehicle operator operates the carriage 28. The hinged tail 110 may be rotated until the end and roller is positioned on or near the ground or other ground surface. Note that the operator can in some situations pull the container 18 onto the hinged tail 110 without raising the hoist 20 and with skill, continue to load the container 18 all the way onto the hoist 20. Also, the operator can, in some situations, pull the container 18 onto the hinged tail 110 with a combination of pulling the container 18 forward and lifting the hinged tail 110. In this regard, in some instances, containers 18, waiting to be loaded onto the vehicle, are “frozen” to the ground and the lifting or hinged tail 110 combination with the cable 32 will effectively break the containers free from the frozen ground.

Another option for use is to pull the container 18 onto the hinged tail member 110 with the hinged tail 110 at the maximum angle with respect to the ground surface. The hinged tail angle provides a steeper angle to load the container 18, which minimizes the potential of the container jumping the side rails 22, 24. With the hinged tail 110 at the maximum angle with respect to the ground, the resultant angular pull of the cable 32 beyond sheave 112 provides greater vertical force and less horizontal force. The reduced horizontal component reduces forces that would cause a misaligned container 18 to jump over the side rails 22, 24 on the hoist 20.

By not having to raise the tilt frame member 20 to the extent necessary with conventional lift frame vehicles, the present disclosure enables the loading and unloading of the container 18 in a significantly faster manner. This increases the number of trips a vehicle operator can perform in a shift and thus lowers costs and increases revenue.

Other types of lifting arrangements are illustrated in assignee's U.S. Pat. No. 8,444,365 entitled “Roll Off Hoist With Hinged Tail And Hydraulic Reeving System”; U.S. Pat. No. 8,465,246 and U.S. Pat. No. 9,446,700, both entitled “Roll Off Hoist With Hinged End Portion; U.S. Pat. No. 7,572,091 entitled “System For Loading/Unloading Containers”, U.S. Pat. No. 7,568,881 entitled “System And Method For Loading/Unloading Containers”, and U.S. Patent Application Publication No. 2013/0084152 entitled “Container Loading System”, all of which are herein incorporated by reference.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A locking mechanism to secure a roll off container to a hoist, comprising:
a guide;
a vertically movable member in the guide, the member movable in the guide under gravitational influence between a locked position and an unlocked position;
a slot is formed in the member to receive a guide pin, the guide pin maintains the member in the guide, and the slot enables vertical movement of the member in the guide such that the member moves into the locked position upon contact with a surface so that the member projects from the guide to lock the roll off container on the hoist and the member reverts to the unlocked position upon removal of the surface so that the member moves into the guide.

2. The locking mechanism of claim 1, wherein the member has an overall elongated rectangular configuration with a pair of parallel sides.

3. The locking mechanism of claim 2, wherein one end between the parallel sides has a taper portion with a radiused corner.

4. The locking mechanism of claim 2, wherein the slot is defined by a pair of parallel edges parallel with the member sides.

5. A vehicle with a roll off container locking mechanism, comprising:
a cab with a frame and powertrain for driving the vehicle;
a hoist positioned on the frame, the hoist moving between a roll off container pick up position and a roll off container transport position;
the locking mechanism coupled with the hoist, the locking mechanism comprising:
a guide;
a vertically movable member in the guide, the member is movable in the guide under gravitational influence between a locked position and an unlocked position;
a slot is formed in the member to receive a guide pin, the guide pin maintaining the member in the guide, and the slot enables vertical movement of the member in the guide such that the member moves into the locked position upon contact with a surface on the frame so that the member projects from the guide to lock the roll off container on the hoist and the member reverts to the unlocked position upon removal of the surface so that the member moves into the guide.

6. The vehicle of claim 5, wherein the member has an overall elongated rectangular configuration with a pair of parallel sides.

7. The vehicle of claim 6, wherein one end between the parallel side has a taper portion with a radiused corner.

8. The vehicle of claim 6, wherein the slot is defined by a pair of parallel edges parallel with the member sides.

9. The vehicle of claim 5, further comprising a front hold down on the hoist adjacent the locking mechanism.

10. The vehicle of claim 9, wherein a portion of the roll off container is locked between the front hold down and the locking mechanism.
